(19) United States
(12) Patent Application Publication
(10) Pub. No.: US 2018/0222066 A1
(43) Pub. Date: Aug. 9, 2018

(54) BEARD TRIMMER WITH ONE OR MORE ROTARY HEADS HAVING A FIXED BLADE WITH A PARTICULAR SHAPE

(71) Applicant: BaByliss Faco sprl, Wandre (BE)

(72) Inventors: Pierre JULEMONT, Soumagne (BE); Olivier SMAL, Magnee (BE)

(73) Assignee: BaByliss Faco sprl, Wandre (BE)

(21) Appl. No.: 15/579,931

(22) PCT Filed: Apr. 22, 2016
(86) PCT No.: PCT/EP2016/059029

§ 371 Date: Dec. 5, 2017

(30) Foreign Application Priority Data
Jun. 8, 2015 (EP) 15170952.4

(51) Int. Cl. B26B 19/14; B26B 19/20

(52) U.S. Cl. CPC B26B 19/143; A46B 15/0079; B26B 19/141; B26B 19/20

(57) ABSTRACT

The present invention relates to a beard trimmer having one or more rotary heads (1), said rotary cutting heads having a moving blade (2) and a fixed blade (3), each head being surrounded by a crown-shaped comb (4), said comb being adjustable in height in order to adjust, in use, the distance between said blades and the skin, and thereby to adapt the cutting of the beard to the desired length, characterized in that the trimmer comprises a fixed bade having a shape characterized by: —a tooth length L3 of 1 to 3 mm, preferably 1.5 to 2 mm; —an opening angle between the teeth of 20 to 30°, preferably 22 to 28°, and more preferably 24 and 27°; —a tooth width L2, at the end of the teeth, of 0.3 to 1 mm, preferably 0.4 to 0.9 mm.

### FIELD OF THE INVENTION

The present invention relates to a beard trimmer comprising one or several rotary cutting heads with a vertical axis. The cutting mechanism of these rotary heads is equipped with a moving blade and a fixed blade. Each cutting head is surrounded by crown-shaped combs, the height of which is adjustable. In use, the combs make it possible to adjust the distance between the cutting mechanism and the skin and thus to adjust the cutting length of the beard. The trimmer according to the invention comprises a type of fixed blade with a particular geometry able to be adapted to any type of beard.

### BACKGROUND OF THE INVENTION

The beard trimmers of the state of the art currently have linear moving and fixed blades, the operation of which is based on a to-and-fro movement of the moving blade relative to the fixed blade. This type of trimmer is generally equipped with a comb that allows it to adjust the cutting length of the beard. Such beard trimmers are for example disclosed in US D 698,084, U.S. Pat. No. 6,978,547, US D 486,267, EP 2 766 153 A1, US D 363,809, US 2013/0042487, U.S. Pat. No. 7,076,878, US D 521,683, etc.

Of course, razors with multiple rotary heads exist that make it possible to achieve a very close shave, but which cannot be used to trim a beard. Razors do not have combs to adjust the distance between the cutting mechanism and the skin. To the best of our knowledge, no beard trimmer with rotary heads exists in the state of the art.

The trimmers of the state of the art have a straight cutting line at the intersection of the moving teeth and fixed teeth. They have the drawback of trimming the hairs differently depending on the trimming direction, since the beard hairs are most often inclined in a direction, given that they almost never grow perpendicular to the skin. The result of trimming with these trimmers is thus very different depending on the movement direction over the beard to be trimmed.

The trimmers that comprise one or several rotary cutting heads with a vertical axis surrounded by crown-shaped combs and comprising fixed blades according to the present invention are not known in the state of the art.

### AIMS OF THE INVENTION

The present invention aims to provide a beard trimmer with one or several rotary heads surrounded by combs with an adjustable length making it possible to adjust the cutting height of the beard, the trimmer being equipped with fixed blades with a particular geometry, and preferably interchangeable so that they may be adapted to any type of beard.

### SUMMARY OF THE INVENTION

The present invention discloses a beard trimmer comprising one or several rotary cutting heads, said rotary cutting heads comprising a moving blade and a fixed blade, each head being surrounded by a crown-shaped comb, said comb being height adjustable and making it possible to adjust, in use, the distance between said blades and the skin and thus to adapt the cutting of the beard hairs to the desired length, characterized in that said trimmer comprises a fixed blade, the geometry of which is characterized by:
a tooth length L3 comprised between 1 and 3 mm, preferably between 1.5 and 2 mm;
an opening angle between the teeth a comprised between 20 and 30°, preferably between 22 and 28°, and particularly preferably between 24 and 27°;
a tooth width L2, at the end of the teeth, comprised between 0.3 and 1 mm, preferably between 0.4 and 0.9 mm.

The preferred embodiments of the invention comprise at least one, or any appropriate combination, of the following features:
the fixed blade comprises between 24 and 54 teeth, preferably between 30 and 45 teeth, and particularly preferably from 32 to 40 teeth;
the diameter of the fixed blade is comprised between 12 and 25 mm, preferably between 18 and 22 mm;
the median axis of the opening angle α passes through the center of the fixed blade;
the median axis of the opening angle α does not pass through the center of the fixed blade;
said fixed blade is interchangeable;
said fixed blade and the moving blade are interchangeable;
said trimmer comprises one, two or three rotary heads;
the height adjustment of the combs is motorized and may be positioned to within half a millimeter;
said comb makes it possible to adjust a distance between the cutting mechanism and the skin comprised between 0 and 20 mm, preferably between 1 and 15 mm, and particularly preferably between 2 and 12 mm with a precision of 0.5 mm.

### BRIEF DESCRIPTION OF THE FIGURES

FIG. 1 shows a beard trimmer according to the invention comprising three rotary heads. The crown-shaped comb around the rotary heads is shown with three different adjustment heights. These three adjustments make it for example possible to obtain hair lengths of 2, 6 and 10 mm.

FIG. 2 shows the trimmer according to the invention with one or two cutting heads, respectively.

FIG. 3 schematically shows the mechanism for adjusting the height of the combs.

FIG. 4 shows a detailed view of the adjustment of the cutting height and the cutting mechanism.

FIG. 5 shows a detailed view of the arrangement of the moving and fixed blades on a vertical axis and the key parameters of the fixed blade.

FIGS. 6 to 9 show three illustrative examples of dimensioning of the fixed blade according to the invention.

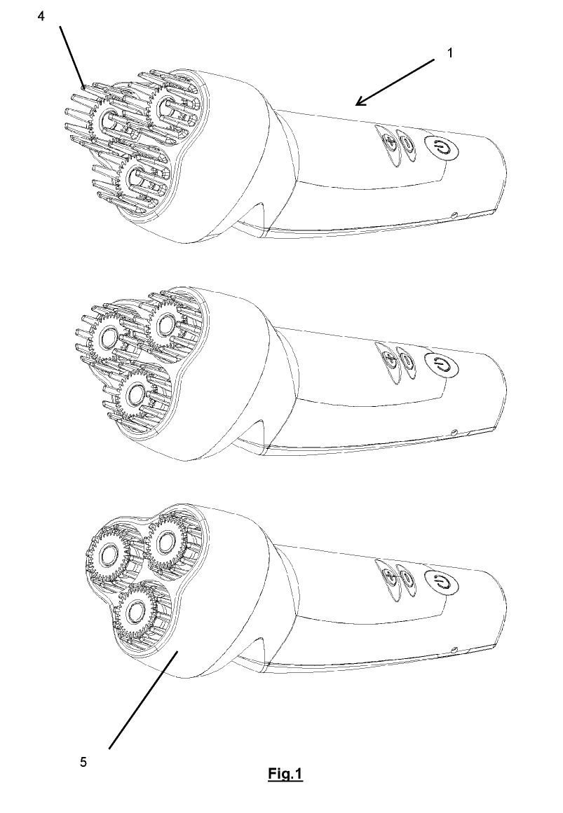

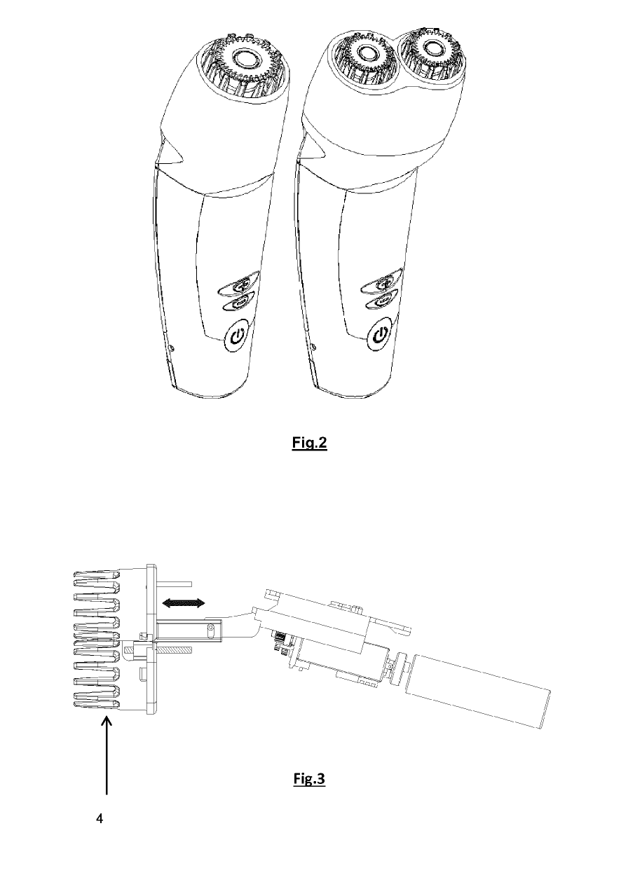

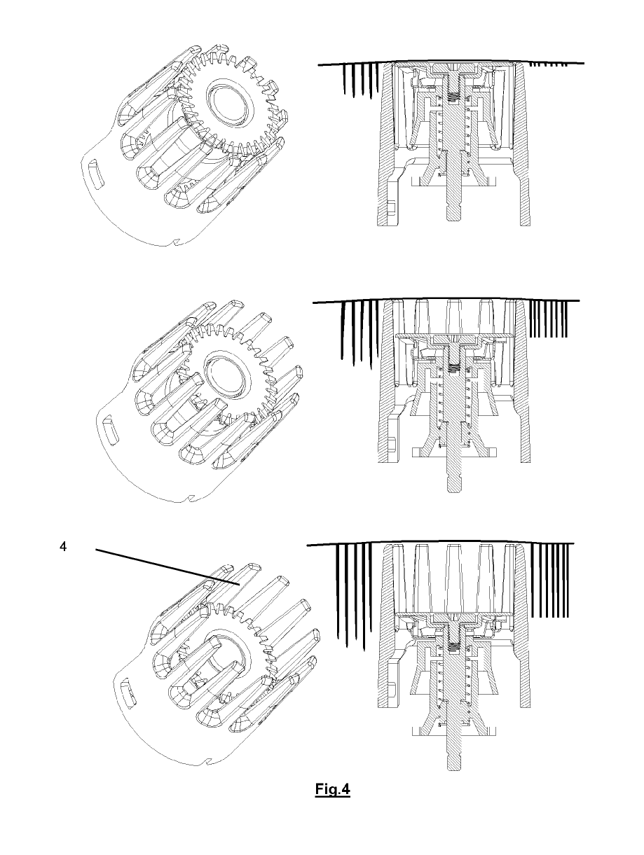

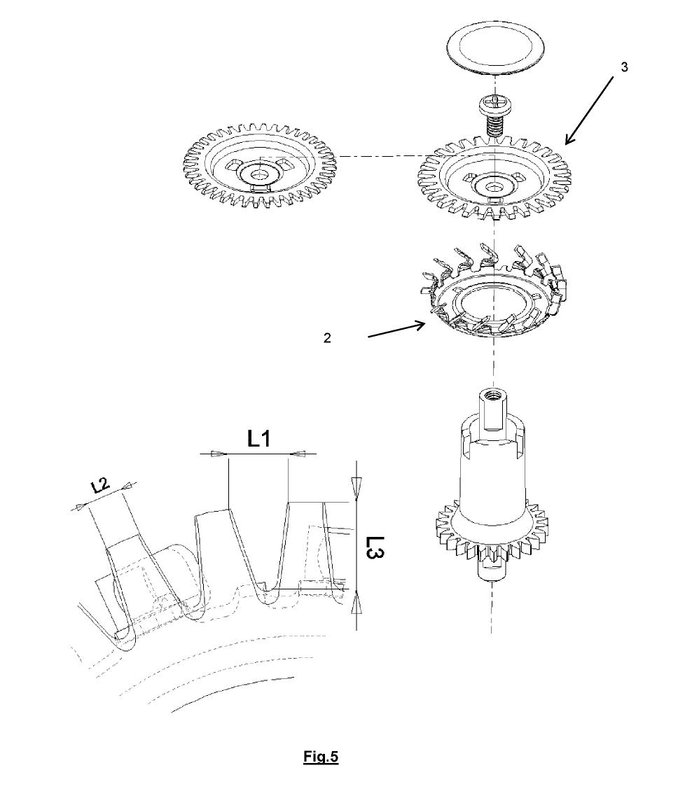

### LIST OF REFERENCE SYMBOLS

1. Circular rotary head with a vertical axis
2. Moving blade
3. Fixed blade
4. Crown-shaped comb surrounding the cutting head
5. Cover

### DETAILED DESCRIPTION OF THE INVENTION

Unlike the beard trimmers of the state of the art, the trimmer according to the present invention has one or several circular rotary heads 1 with a vertical axis, surrounded by crown-shaped combs 4, the height of which can be adjusted to within half a millimeter. This adjustment can be manual or motorized (not shown). This trimmer allows a movement in arcs of circle over the beard, just like a rotary head razor. This type of movement has the advantage of beginning to trim the hairs from all sides, irrespective of the incline thereof relative to the skin, which results in uniform trimming of the beard.

The movement of the combs 4 raises the hairs, which ultimately penetrate from the outside toward the inside via the space left between two teeth in the trimming zone. The particular shape of the teeth of the comb 4, which become gradually finer toward the tip, allows easy penetration of the beard hairs toward the trimming element made up of a fixed blade 3 and a moving blade 2.

The height of the telescoping combs 4 can be adjusted approximately between 0 and 15 mm, preferably between 0 and 12 mm, and particularly preferably between 0 and 10 mm. The combs are therefore almost completely retractable in the cover 6 to occupy less space when storing the trimmer.

The cover 5 surrounding the rotary head(s) is removable to facilitate cleaning of the cutting mechanism.

The fixed blade 3 comprises radial notches, where the notches form a symmetrical or asymmetrical angle with the line joining the axis of the fixed blade, which favors the penetration of the hairs in the cutting mechanism.

The thickness of the hairs of a beard and their density is very variable from one person to the next. It is therefore sometimes difficult to anticipate which type of fixed blade will work optimally for the user. The trimmer according to the invention therefore comprises moving and fixed blades, which are preferably interchangeable. In one preferred embodiment of the invention, the trimmer may be accompanied by a set of interchangeable blades.

Furthermore, the wear of the blade may also be greater than the wear of razor blades, which may require more frequent replacement of the blades.

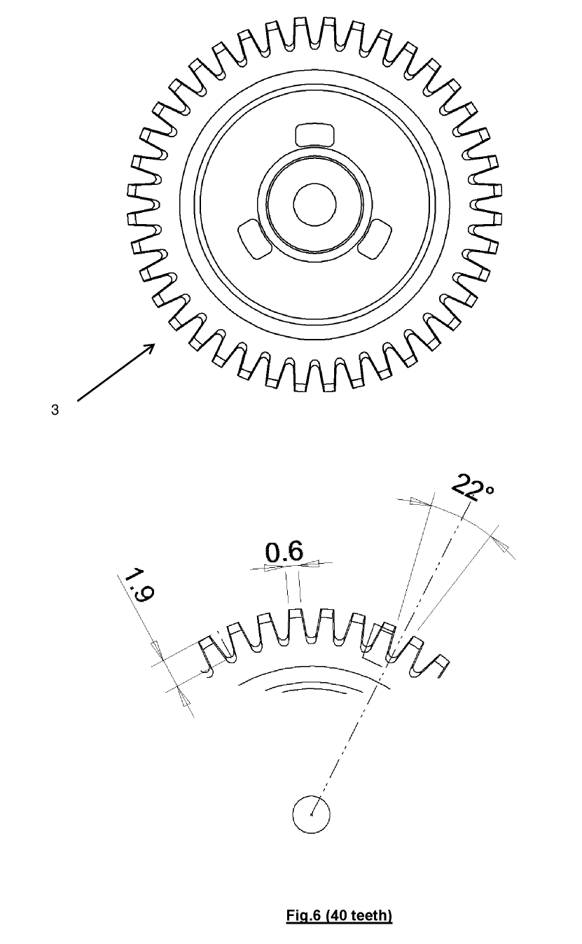

The key parameters of the fixed blade are shown in FIG. 5. L1 represents the distance between the teeth of the fixed blade on the outer diameter thereof. L2 represents the width of the end of the tooth on the outer diameter of the blade. L3 represents the length of the tooth, and a represents the opening angle between two teeth of the fixed blade.

The fixed blades may have a highly variable tooth length L3. It may vary from 0.5 to 4 mm, but it is generally comprised between 1 and 3 mm, preferably between 1.5 and 2 mm. The length chosen for the teeth must of course relate to the diameter of the fixed blade and the number of teeth that are considered. Thus, a blade with a large diameter, for example 25 mm, and a small number of teeth allows a greater tooth length L3 than with a large number of teeth. The fixed blade generally comprises between 24 and 54 teeth, preferably between 30 and 45 teeth. The diameter of the fixed blade is generally comprised between 12 and 25 mm, preferably between 18 and 22 mm.

Mechanical stresses and aggressive contacts with the skin also require the blade manufacturer to retain a certain tooth width L2 at the end of the teeth. In this case, the latitude is generally comprised between 0.3 and 1 mm, preferably between 0.4 and 0.9 mm.

Furthermore, the dimensions L2 and L3 naturally determine the opening angle α, and therefore L1 for a same diameter. The opening angle α is generally comprised between 20 and 30°, preferably between 22 and 28°. This opening angle α is defined by a median axis that does not necessarily have to pass through the center of the fixed blade. In this case, this angle is referred to as an “asymmetrical angle”.

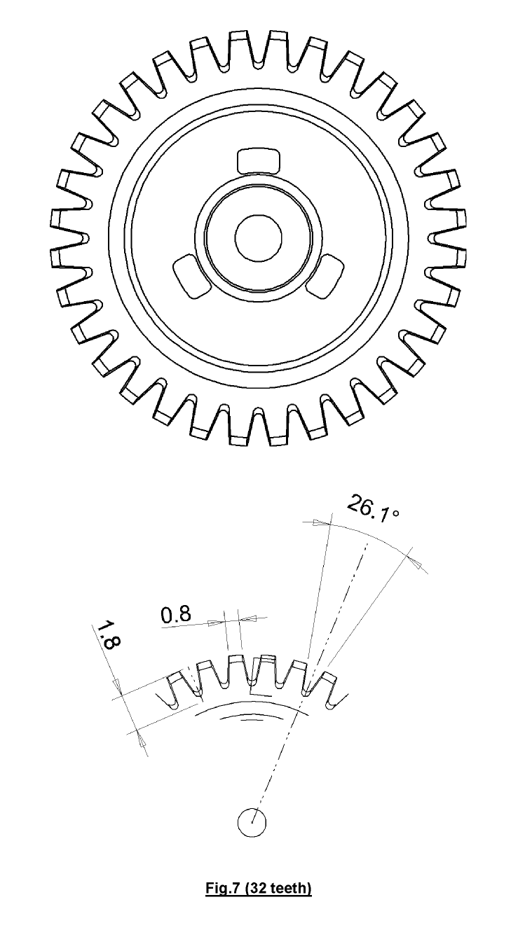

Of course, the present invention excludes combinations of the dimensions L2, L3 and a that are geometrically impossible, and one skilled in the art will only take account of the combinations of the parameters that are technically achievable. Illustrative examples of dimensioning are given in FIGS. 6 to 9.

### EXAMPLES

### Example 1

FIG. 6 shows a fixed blade with 40 teeth and an opening angle between the teeth that is symmetrical relative to the radius of the fixed blade. In this example, L3=1.9 mm; L2=0.6 mm and α=22°.

### Example 2

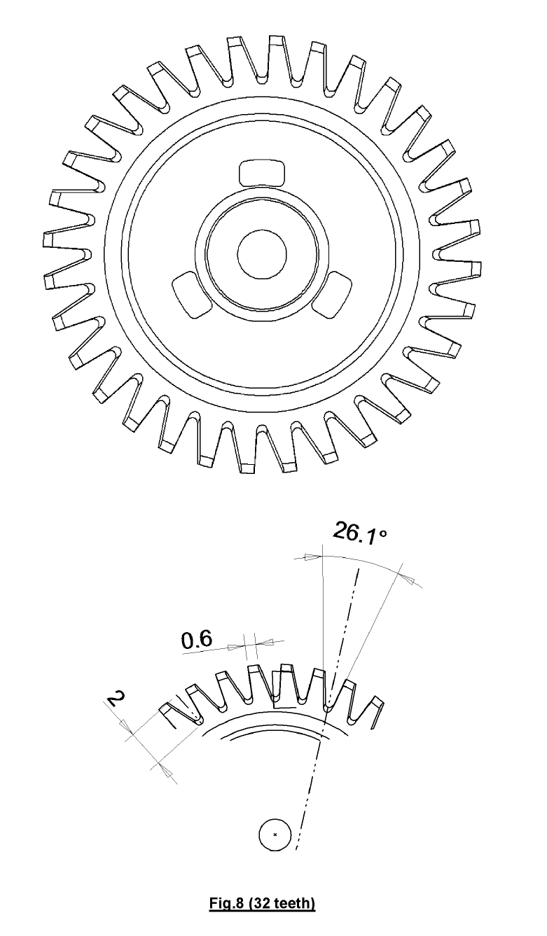

FIG. 7 shows a fixed blade with 32 teeth and an opening angle between the teeth that is symmetrical relative to the radius of the fixed blade. In this example, L3=1.8 mm; L2=0.8 mm and α=26.1°.

### Example 3

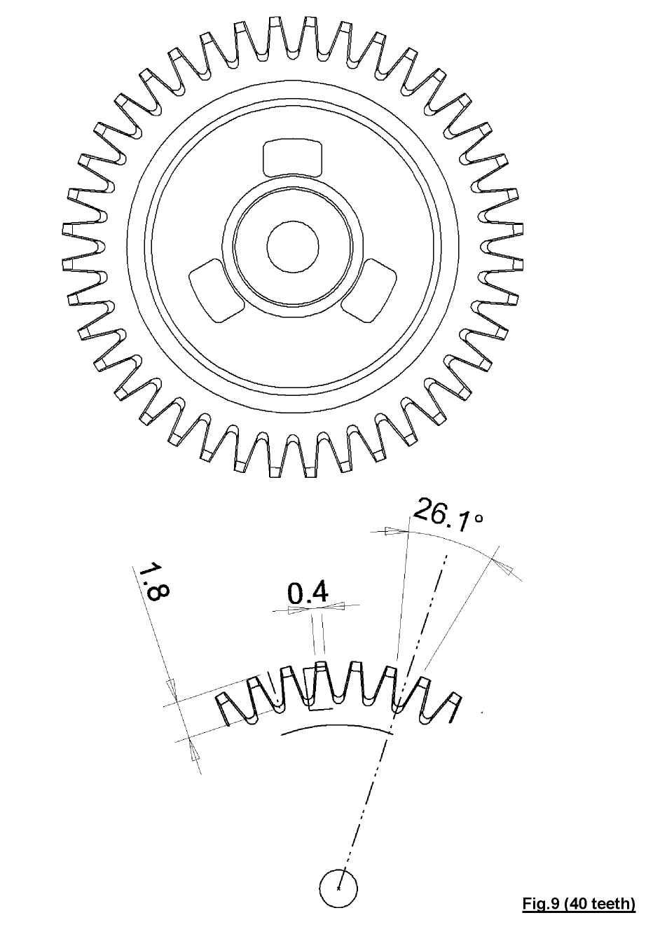

FIG. 8 shows a fixed blade with 32 teeth and an opening angle between the teeth that is asymmetrical relative to the radius of the fixed blade. In this example, L3=2 mm; L2=0.6 mm and α=26.1°.

### Example 4

FIG. 9 shows a fixed blade with 40 teeth and an opening angle between the teeth that is symmetrical relative to the radius of the fixed blade. In this example, L3=1.8 mm; L2=0.4 mm and α=26.1°.

1. A beard trimmer comprising one or several rotary cutting heads, said rotary cutting heads comprising a moving blade and a fixed blade, each head being surrounded by a crown-shaped comb, said comb being height adjustable and making it possible to adjust, in use, the distance between said blades and the skin and thus to adapt the cutting of the beard hairs to the desired length, wherein said trimmer comprises a moving blade and a fixed blade, the geometry of the fixed blade is characterized by:
a tooth length L3 comprised between 1 and 3 mm, preferably between 1.5 and 2 mm;
an opening angle between the teeth a comprised between 20 and 30°, preferably between 22 and 28°, and particularly preferably between 24 and 27°;
a tooth width L2, at the end of the teeth, comprised between 0.3 and 1 mm, preferably between 0.4 and 0.9 mm.

2. The beard trimmer according to claim 1, wherein said fixed blade comprises between 24 and 54 teeth, preferably between 30 and 45 teeth, and particularly preferably from 32 to 40 teeth.

3. The beard trimmer according to claim 1, wherein the diameter of the fixed blade is comprised between 12 and 25 mm, preferably between 18 and 22 mm.

4. The beard trimmer according to claim 1, wherein the median axis of the opening angle α passes through the center of the fixed blade.

5. The beard trimmer according to claim 1, wherein the median axis of the opening angle α does not pass through the center of the fixed blade.

6. The beard trimmer according to claim 1, wherein said fixed blade is interchangeable.

7. The beard trimmer according to claim 1, wherein said fixed blade and the moving blade are interchangeable.

8. The beard trimmer according to claim 1, wherein said trimmer comprises one, two or three rotary heads.

9. The beard trimmer according to claim 1, wherein the adjustment of the height of the combs is motorized and may be positioned to within half a millimeter.

10. The beard trimmer according to claim 1, wherein said comb makes it possible to adjust a distance between the cutting mechanism and the skin comprised between 0 and 20 mm, preferably between 1 and 15 mm, and particularly preferably between 2 and 12 mm with a precision of 0.5 mm.
